(19) United States
(12) Patent Application Publication
(10) Pub. No.: US 2026/0228556 A1
(43) Pub. Date: Aug. 6, 2026

(54) UNIFIED DIFFUSION TRANSFORMER MODEL BASED ON COUPLED VIDEO AND ACTION DIFFUSION

(71) Applicant: Toyota Research Institute, Inc., Los Altos, CA (US)

(72) Inventors: Chuning Zhu, Seattle, WA (US); Paarth Shah, Somerville, MA (US); Siyuan Feng, Somerville, MA (US); Benjamin Burchfiel, Somerville, MA (US); Abhishek Gupta, Seattle, WA (US)

(73) Assignees: Toyota Research Institute, Inc., Los Altos, CA (US); Toyota Jidosha Kabushiki Kaisha, Toyota-shi (JP); University of Washington, Seattle, WA (US)

(21) Appl. No.: 19/433,368

(22) Filed: Dec. 26, 2025

Related U.S. Application Data
(60) Provisional application No. 63/752,596, filed on Jan. 31, 2025.
(60) Provisional application No. 63/778,634, filed on Mar. 27, 2025.

(51) Int. Cl. G06N 3/096; G06N 3/045

(52) U.S. Cl. CPC G06N 3/096; G06N 3/045

(57) ABSTRACT

An apparatus for training a machine learning (ML) model. One embodiment of an apparatus includes one or more processors coupled to one or more memories and configured to: obtain a first training dataset comprising data of a first modality; obtain a second training dataset comprising data of a second modality; and perform a joint diffusion process to train a unified diffusion transformer model, the joint diffusion process comprising (1) a first diffusion process based on the first training dataset, and (2) a second diffusion process based on the second training dataset, the first diffusion process and the second diffusion process being performed at decoupled diffusion timesteps.

### CROSS-REFERENCE TO RELATED APPLICATIONS

This Application claims the benefit of and priority to U.S. Provisional Patent Application No. 63/752,596, filed on Jan. 31, 2025, and U.S. Provisional Patent Application Ser. No. 63/778,634, filed on Mar. 27, 2025, the entire contents of each of which are hereby incorporated by reference.

### TECHNICAL FIELD

Embodiments described herein generally relate to training of machine learning models, more specifically, to training a unified diffusion transformer model that is capable of generating a prediction related to an action by a robot or a future image based on forward dynamics, inverse dynamics, marginal action distribution, or marginal image distribution.

### BACKGROUND

Artificial intelligence is a concept for simulating human intelligence, where machine learning allows an algorithm (e.g., a model), such as an artificial intelligence algorithm, to learn from, and make decisions based on, data without being deterministically programmed for making such decisions. A machine learning model includes a plurality of layers of parameters that are used to predict an output given an input. The machine learning model may be trained, such that the parameter weights of the model may be optimized to enable the model to provide or predict an accurate output given the input. Although there have been technological advancements over the years related to machine learning models and training of machine learning models, challenges still exist. Accordingly, improved systems, apparatuses, and/or methods of machine learning and/or machine learning model training are desired.

### SUMMARY

Systems, apparatuses, and methods for training a machine learning (ML) model or performing an inference using a trained ML model are described. One embodiment of an apparatus includes one or more processors coupled to one or more memories and configured to: obtain a first training dataset comprising data of a first modality; obtain a second training dataset comprising data of a second modality; and perform a joint diffusion process to train a unified diffusion transformer model, the joint diffusion process comprising (1) a first diffusion process based on the first training dataset, and (2) a second diffusion process based on the second training dataset, the first diffusion process and the second diffusion process being performed at decoupled diffusion timesteps.

In another embodiment, a method includes obtaining a first training dataset comprising action data; obtain a second training dataset comprising video data; and performing a joint diffusion process to train a unified diffusion transformer model, the joint diffusion process comprising (1) an action diffusion process based on the first training dataset, and (2) a video diffusion process based on the second training dataset, the action diffusion process and the video diffusion process being performed at decoupled diffusion timesteps.

In yet another embodiment, an apparatus includes one or more processors coupled to one or more memories and configured to: send, to a machine learning model, an input comprising a current image; and obtain, from the machine learning model, an output comprising one or more of: an action by a robot, or a future image, wherein: the machine learning model comprises a unified diffusion transformer model trained based on a joint diffusion process comprising (1) an action diffusion process based on a first training dataset comprising action data, and (2) a video diffusion process based on a second training dataset comprising video data, and the machine learning model is capable of performing one or more of: generating a first prediction based on forward dynamics, generating a second prediction based on inverse dynamics, generating a third prediction based on marginal action distribution, or generating a fourth prediction based on marginal image distribution.

In another embodiment, a method includes sending, to a machine learning model, an input comprising a current image; and obtaining, from the machine learning model, an output comprising one or more of: an action by a robot, or a future image, wherein: the machine learning model comprises a unified diffusion transformer model trained based on a joint diffusion process comprising (1) an action diffusion process based on a first training dataset comprising action data, and (2) a video diffusion process based on a second training dataset comprising video data, and the machine learning model is capable of performing one or more of: generating a first prediction based on forward dynamics, generating a second prediction based on inverse dynamics, generating a third prediction based on marginal action distribution, or generating a fourth prediction based on marginal image distribution.

These and additional features provided by the embodiments of the present disclosure will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 is a block diagram illustrating an example system of a unified diffusion transformer model, according to embodiments described herein;

FIG. 2 is a block diagram illustrating examples of training and inference of a unified diffusion transformer model, according to embodiments described herein;

FIGS. 3A, 3B, 3C, and 3D include tables of information or data related to a unified diffusion transformer model, according to embodiments described herein;

FIG. 4 is a block diagram illustrating components of an example ML model system, according to embodiments described herein;

FIG. 5 is a flow chart depicting an example process for training an ML model, according to embodiments described herein;

FIG. 6 is a flow chart depicting an example process for performing an inference using a trained ML model, according to embodiments described herein; and

FIG. 7 is a block diagram illustrating computing hardware utilized in one or more devices for implementing various processes and systems, according to embodiments described herein.

### DETAILED DESCRIPTION

Certain embodiments of the present disclosure provide apparatuses, methods, processing systems, and computer-readable mediums for training a unified diffusion transformer model that is capable of generating a prediction related to an action by a robot or a future image based on forward dynamics, inverse dynamics, marginal action distribution, or marginal image distribution.

Imitation learning is an approach towards building generalist robots. However, scaling imitation learning for large robot foundation models remains challenging due to its reliance on high-quality expert demonstrations. Meanwhile, large amounts of video data depicting a wide range of environments and diverse behaviors are readily available. This data provides a rich source of information about real-world dynamics and agent-environment interactions. Leveraging this data directly for imitation learning, however, may be challenging due to the lack of action annotation. Certain embodiments of the present disclosure present a framework (referred to herein as a Unified World Model (UWM) or a unified diffusion transformer model) that allows for leveraging both video and action data for policy learning. Specifically, a UWM integrates an action diffusion process and a video diffusion process within a unified transformer architecture, where independent diffusion timesteps govern each modality. By controlling each diffusion timestep, the UWM can flexibly represent a policy, a forward dynamics, an inverse dynamics, and/or a video generator. Through experiments described herein, it is shown that: (1) UWM enables effective pretraining on large scale multitask robot datasets with both dynamics and action predictions, resulting in more generalizable and robust policies than imitation learning, (2) UWM naturally facilitates learning from action-free video data through independent control of modality-specific diffusion timesteps, further improving the performance of finetuned policies. These results suggest that UWM offers an improved step toward harnessing large, heterogeneous datasets for scalable robot learning, and provides an efficient unification between the often disparate paradigms of imitation learning and world modeling.

Imitation learning provides a way to imbue autonomous robots with complex behaviors using human demonstrations. Imitation learning via supervised learning, often referred to as behavior cloning (BC), may be based on multimodal generative models such as diffusion or flow-based models. With these methods, acquiring new behaviors amounts to collecting demonstrations and fitting a generative model to the action distributions given observations. However, these methods can be brittle when tasked beyond its training distribution. One way to address such challenge may be to scale up the number of high-quality, on-robot demonstrations collected through robotic teleoperation. However, this data scaling process is expensive and time-consuming.

While imitation learning methods may learn a mapping from states to optimal actions, they do not explicitly capture temporal dynamics that are naturally present in demonstration trajectories or videos. An alternative paradigm that can leverage such dynamics information is that of world modeling: learning approximate models of how the world changes over time. Commonly instantiated as predicting the future observations given current observations (and actions), world models can be trained from large scale robotic datasets, but also from alternative sources of data such as un-curated “play” data or even action-free data such as videos. Certain world modeling techniques, such as video diffusion models or latent state-space modeling, may be used for realistic generation of future frames. However, there may be certain challenges in the ability of these world models to capture temporal dynamics being brought to bear on improving the robustness and generalization of robotic controllers synthesized via imitation learning.

Imitation learning (IL) for robotics is a paradigm in which robots learn to perform tasks by learning behaviors from experts, typically via teleoperation. A common approach within the imitation learning family is behavior cloning, where supervised learning techniques are applied to replicate expert actions from the provided demonstrations. In particular, these methods are used for tasks with well-defined inputs such as manipulation.

One common challenge for problems cast in the BC framework is the inability to fit multi-modal action distributions. Certain existing methods have attempted to solve this by attempting to fit multiple pre-defined distributions, using architectures amenable to modeling high-dimensional distributions, as well as generative models such as diffusion models. Diffusion models have shown to scale favorably to both a large number of demonstrations and dexterous behaviors. Although the diffusion framework has shown the ability to scale, at their core, these formulations rely on access to high quality action data. Despite efforts to open source large amounts of data, the magnitudes of readily available data pales in comparison to the Internet scale data that is used to train state of the art foundation models such as LLMs (Large Language Models) and VLMs (Vision Language Models). Alternative formulations to scaling robotic policies focus on leveraging pre-trained foundation models in order to leverage their common-sense reasoning using autoregressive techniques. These efforts are heavily reliant on access to high quality action data and focus on increasing generalization.

In order to scale large robot foundation models, an approach may be in leveraging video as a source of abundant data. Video data, however, does not contain explicit actions and may contain a significant cross-embodiment gap. In order to address these issues, hand-engineered solutions are often used in order to extract semantic information and map this information to the physical robot. For example, certain existing methods may use key points to map actions from video models to the robots themselves. Alternative methods use predicted future points and maps these to rigid body transforms explicitly in order to transfer from Internet trained videos to robots. Other work often explicitly track human hand trajectories and contact patches in order to leverage data from human videos.

An alternative approach to leveraging video data may rely on large scale pretraining on robot video datasets. For example, some existing methods may use an autoregressive style prediction to pretrain a video and language model which is then finetuned on robot actions in a second stage. Other approaches may use diffusion models in order to predict and supervise on dense future frames combined with an action diffusion transformer. These use a two-stage process that relies on finetuning pretrained vision models that may not contain robot information. By using a decoupled architecture, they limit the feature sharing capabilities between the video and action data. Another existing method trains a joint video-action model using diffusion as its core mechanism. This approach, however, uses a shared diffusion timestep between all the modalities which may lead to a sub-optimal shared representation that lacks a causal understanding between the underlying video and action models. By having independent diffusion timesteps, embodiments described herein perform better in both in distribution and out of distribution scenarios.

Certain existing methods combine autoregressive and more continuous approaches. However, multi-modal feature sharing capabilities have not been shown. Unified multi-modal models for both decision making and general inference may use feature sharing between modalities. Embodiments described herein utilize the feature sharing for the application of joint video and action modeling.

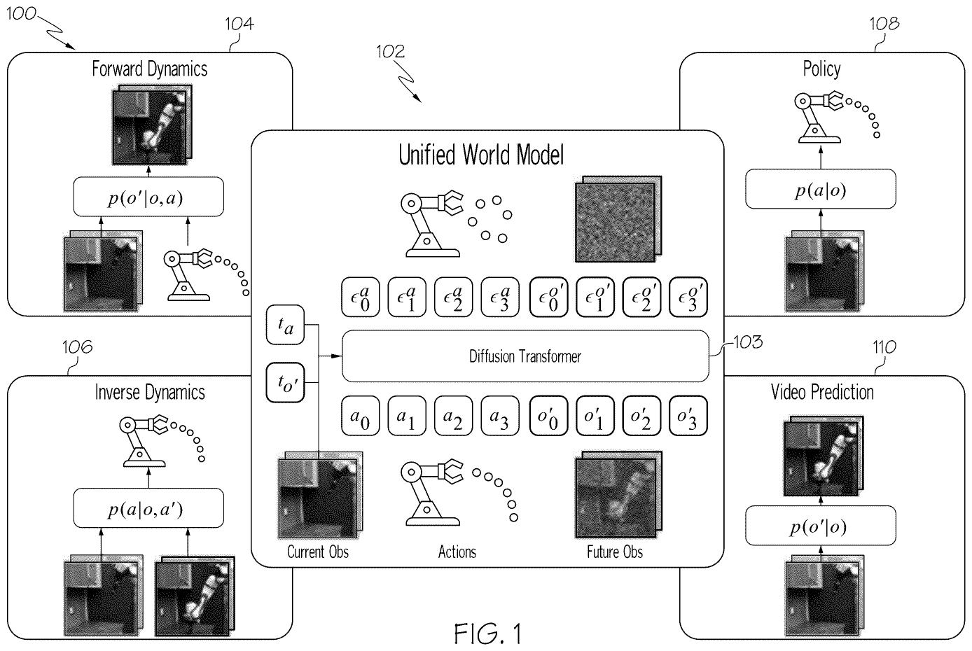

Certain embodiments of the present disclosure provide a technical solution to the technical challenges described above by providing a diffusion-based learning framework that unifies imitation learning and world modeling, incorporating knowledge of temporal dynamics gleaned from large robotic datasets into imitation learning policies. This solution integrates an action diffusion process and an image diffusion process into a single diffusion transformer model conditioned on independent diffusion timesteps. Leveraging a connection between diffusion noise at different timesteps of the forward diffusion noising process and partial “masking,” this solution allows for flexible sampling from a number of distributions by manipulating the diffusion timesteps independently at inference time. For example, to draw a sample from the policy, the solution described herein can “mask out” the image diffusion process by fixing the image diffusion timestep to a certain timestep (e.g., T). Similarly, the solution can sample from the forward dynamics model by fixing the action diffusion timestep to 0, inferring next observations given current observations and “clean” actions. Same holds for inverse dynamics models and unconditional video prediction models into the future. This yields a simple, unified diffusion model that can serve as a policy, dynamics model, video predictor, or inverse model, as described further herein with respect to FIG. 1.

In some embodiments, a UWM may be or include a coupled score model that predicts action scores and future image scores, conditioned on the current image and separate diffusion timesteps for action and future image. During training, the timesteps are sampled independently at random, exposing the model to different combinations of action and image noises. During inference, the UWM enables flexible sampling from various distributions by manipulating the diffusion timesteps independently. In particular, the UWM can generate samples from (1) forward dynamics, (2) inverse dynamics, (3) marginal action distribution (policy), and/or (4) marginal image distribution (video generative model). This learning framework leads to improved policies compared to standard imitation learning since, (1) the unified architecture enables feature sharing between actions and pixels (e.g., of an image or video), resulting in additional supervision from the same data; (2) the model captures all combinations of marginal and conditional distributions, acquiring an understanding of the causal relationship between actions and images; and (3) the model can learn from broader data modalities such as action-free videos.

The effectiveness of UWM may be shown through a set of experiments across certain robotic manipulation tasks. For example, certain results described herein show that UWM is capable of extracting knowledge from multitask robotic datasets, and further leverage action-free video data to improve its generalization to out-of-distribution conditions. These models are able to flexibly perform a variety of test-time inference, while retaining strong performance of both policy and dynamics prediction, thereby bridging the gap between policies and world models for robot learning.

In certain embodiments, unified world models (e.g., a unified diffusion transformer model) may use or build on the framework of denoising diffusion probabilistic models and their application to problems in robotic control.

Denoising Diffusion Probabilistic Models (DDPMs) are a family of generative models that define a forward noising process and a learned reverse denoising process to generate samples from a complex, multimodal data distribution. With p(x₀) denoting the data distribution from which a number of samples are available, in the forward diffusion process, the data x₀~p(x₀) is gradually corrupted by iteratively adding Gaussian noise over T steps through a Markov chain according to a variance schedule. After T steps, x_{T} is nearly an isotropic Gaussian. The corresponding reverse process aims to map x_{T} back to a clean sample x₀ from the data distribution by iteratively denoising. While the exact reverse conditional of the forward diffusion process referred to above is generally intractable, one can learn a parametrized approximation. In practical settings, the variance of the reverse conditional of the forward diffusion process may be set to a simple time varying constant. To approximate the conditional expectation related to the optimal mean under Maximum Likelihood Estimation (MLE), DDPMs may train a neural network using a variant of denoising score matching. This “score function” predicts the noise added at each step using a simple regression objective. This learned noise prediction network can then directly parameterize the reverse diffusion process.

Given this reverse diffusion model, samples can approximately be drawn from the data distribution using a simple “denoising procedure.” Starting with a sample x_{T} drawn from Gaussian noise, new samples are iteratively drawn until a “clean sample” x₀ is obtained. This procedure allows for the representation of complex multimodal distributions where performing MLE tractably is challenging.

While the above-mentioned generative modeling process is unconditional, diffusion models can be naturally extended to conditional settings. That is, for a setting where multivariate data is available, and a conditional distribution must be modeled, a bulk of the steps described above can be reused, such as with an additional conditioning variable. The forward process remains identical, while the reverse process may be modified. In this case, the expectation related to the reverse process can be approximated using a conditional noise prediction network that is also trained with denoising score matching.

### Embodiments Related to Unified World Models

In certain embodiments, Unified World Models may provide a way to incorporate temporal dynamics into diffusion-based action prediction models, proving a bridge between the often disparate worlds of imitation learning and world modeling. Additional details regarding certain aspects of the present disclosure are described further in Chuning Zhu et al., “Unified World Models: Coupling Video and Action Diffusion for Pretraining on Large Robotic Datasets” (https://arxiv.org/pdf/2504.02792), the entire contents of which are hereby incorporated by reference. Moreover, while certain aspects are described with respect to certain modalities (e.g., action data and video data), other modalities (e.g., additional or fewer modalities), including text data as an example, may also be used with some aspects, consistent with the present disclosure.

Certain embodiments may be related to sequential decision making settings, and use or obtain a dataset of (observation, action, next observation) pairs which may be provided by an expert demonstrator. In some examples, the environment may be Markovian in observations. In addition to this action-labeled dataset, these embodiments may also use or obtain an action-free dataset. These can be used to extract the learning signal for synthesizing robot controllers, for example.

In this context of synthesizing robot controllers, several different models may be desired: (1) a policy that samples optimal actions to execute at a particular observation; (2) a dynamics model that samples future observations, given a current observation and action; (3) an inverse model that predicts what distribution of actions can transition between a current observation and a desired next observation; and (4) a video prediction model that predicts marginal future observations given current ones. While these models each have use in different contexts, they are largely considered to be disparate fields of study. In certain embodiments of the present disclosure, these are provided as different possibilities or capabilities of the same model, where they can be unified into a single model to benefit each other.

Some embodiments of the present disclosure provide a single (e.g., unified) diffusion model (e.g., a unified diffusion transformer model) that can be trained on samples from the joint distribution of data for observation, action, and next observation and used to flexibly perform inference for the policy, the dynamics model, the inverse model, and/or the video prediction model, with minimal modifications to test-time inference.

In some embodiments, a joint diffusion model may be instantiated, which integrates next observation prediction and action prediction into a single diffusion model conditioned on current observation. This can be done by parameterizing a joint noise prediction network that approximates a conditional expectation over both action and next observation noise, with parameters related to noise on actions and next observations, and the coupled timestep of the joint diffusion process. In certain examples, o may refer to the current observation, o′ₜ may refer to timestep t in the diffusion process for the next observation, and aₜ may refer to timestep t in the diffusion process for action. However, training such a joint noise prediction network may not accomplish flexible inference since it can only sample from the joint distribution of (a, o′).

For flexible inference, certain embodiments may leverage a connection between diffusion timesteps and “masking,” where noising input tokens by setting the inference timestep for diffusion appropriately can induce a form of partial masking. Timesteps closer to T (fully noised) may indicate full masking, while timesteps closer to 0 (un-noised) may indicate no masking. Based on this, UWM modifies the joint diffusion process discussed above and decouples the timesteps between that of the diffusion processes of next observation prediction t_{o′} and that of action prediction tₐ in a joint noise prediction network. This separation of timesteps allows for independent control of t_{o′} and tₐ during training and inference, which gives rise to flexible inference capabilities.

A UWM models a coupled noise prediction network that approximates a conditional expectation over noise, such as related to noise on next observations and actions, and to the decoupled timesteps of the diffusion process with respect to actions and next-observations, respectively. The ability to set diffusion timesteps independently allows for marginalization and conditioning of different variables. Fixing the timestep for either t_{o′} or tₐ to T marginalizes the corresponding variable a, o′, while setting the timestep to 0 performs conditioning. By setting timestep t_{o′}=T, the joint model is approximating the expectation related to o′_{T}. Since o′_{T} is approximately an isotropic Gaussian, this reduces such expectation to an expectation that represents the policy described herein, thereby performing marginalization. Similarly, setting the timestep t_{o′}=0 reduces the approximated distribution to an expectation that corresponds to an inverse model, thereby performing conditioning. Setting combinations of t_{o′} and tₐ allows for flexible inference of policies, dynamics models, inverse models, and/or video prediction from the same model.

This leads to a training scheme using a modification to the standard denoising objective. To train a joint noise prediction diffusion model, action timestep tₐ and next observation timestep t_{o′} may be independently sampled, such as to draw noisy action and next observation samples from their respective distributions, and the coupled conditional score model may be trained, conditioned on the current observation with a standard denoising objective across both actions and next-observations, where weights may be chosen for trade-off between the action prediction and next observation prediction objectives. This training paradigm exposes the model to all combinations of noise levels of the modalities. At inference, samples from various distributions can be flexibly drawn by controlling the timesteps t_{o′} and tₐ as follows.

To sample from the policy, the next observation o′ may be marginalized out by setting t_{o′}=T and o′_{T}~N (0, I). The reverse diffusion process may be performed on actions going from tₐ=T, . . . , 1 with a_{T}~N (0, I).

To sample from the video prediction model, the action a may be marginalized out by setting tₐ=T and a_{T}~N (0, I). The reverse diffusion process may be performed on next observations going from t_{o′}=T, . . . , 1 with o′_{T}~N (0, I).

To sample from the forward dynamics model, a particular action a may be conditioned by setting tₐ=0 and a₀=a. The reverse diffusion process may be performed on next observations going from t_{o′}=T, . . . , 1 with o′_{T}~N (0, I).

To sample from the inverse dynamics model, a particular next observation o′ may be conditioned by setting t_{o′}=0 and o₀=o. The reverse diffusion process may be performed on actions going from tₐ=T, . . . , 1 with a_{T}~N (0, I).

The modification described above to the standard diffusion training paradigm allows a single model to be trained, benefiting from feature sharing between different models of action and future observation prediction. This model can then be flexibly used for inference with just the choice of timesteps, making it a versatile, general-purpose decision-making model.

FIG. 1 is a block diagram illustrating an example system 100 of a unified diffusion transformer model 102. As depicted, the unified diffusion transformer model 102 includes a diffusion transformer 103 that is trained based on the joint diffusion process described herein where the timesteps between that of the diffusion processes of next observation prediction and that of action prediction are decoupled in a joint noise prediction network. In certain embodiments, the unified diffusion transformer model 102 is capable of performing one or more of forward dynamics 104, inverse dynamics 106, policy 108, or video prediction 110 as described herein. For example, the unified diffusion transformer model 102 trained (e.g., pretrained) based on the diffusion process with decoupled timesteps for next observation prediction (which may be discussed herein in terms of video prediction or image prediction, or similar) and action prediction may be capable of performing all of forward dynamics 104, inverse dynamics 106, policy 108, and video prediction 110 as described herein. The unified diffusion transformer model 102 integrates action and video diffusion in a unified transformer architecture controlled by modality-specific diffusion timesteps. The model can be trained on large robotics datasets and then flexibly perform a variety of different inferences at test time. This enables improved robustness and generalization for imitation learning.

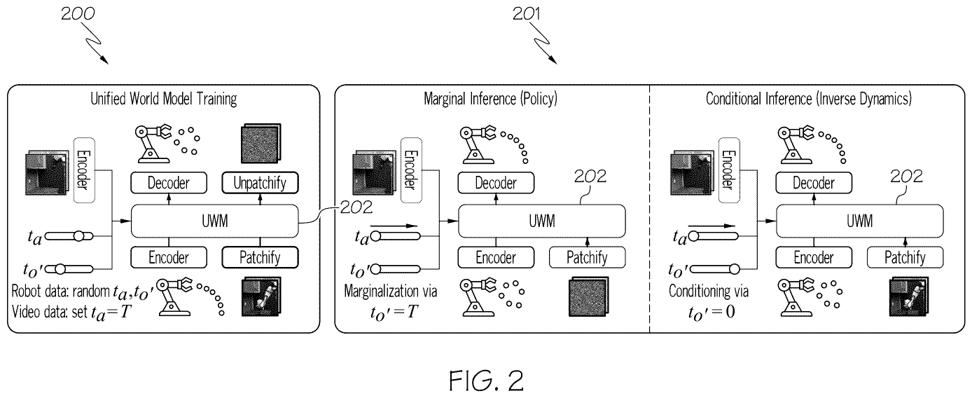

In certain embodiments, the UWM may be modeled as a diffusion transformer as shown in FIG. 2. The model predicts actions (e.g., corresponding to control signals related to how a robot or a robot component may be manipulated to perform certain actions by the robot) and/or observation noises given current observations o, noisy actions aₜₐ, noisy observations o′_{to′}, action timestep tₐ, and/or observation timestep tₒ. The actions are action chunks of length hₐ. The current observations o and next observations o′ are frame-stacked observations of length hₒ from n_{c} camera views.

FIG. 2 is a block diagram illustrating examples 200, 201 of training and inference of a unified diffusion transformer model (e.g., the unified diffusion transformer model 102 of FIG. 1). The example 200 shows UWM (e.g., the unified diffusion transformer model 102 of FIG. 1) pretraining on robot trajectories with actions and co-training on action-free videos by masking out actions using diffusion timesteps. The example 201 illustrates marginal and conditional inference modes, corresponding to the policy 108 of FIG. 1 and the inverse dynamics 106 of FIG. 1.

To condition the model on current observations, each frame from each camera view (e.g., from a camera on or coupled or connected to a robot) may be encoded (e.g., using a ResNet-18 encoder) to obtain an n_{embd} dimension feature. The features may be concatenated to form an embedding of size n_{c}·hₒ·n_{embd}. In some cases, the diffusion timesteps may be encoded using a shared sinusoidal timestep encoder, resulting in two timestep embeddings. These timestep embeddings may be concatenated with the image features, and the combined features may be used to condition the transformer, such as via Adaptive Layer Normalization (AdaLN).

The context of the diffusion transformer may include action embeddings and image embeddings. The action embeddings are obtained by encoding the action chunk per timestep (e.g., using a shallow Multilayer Perceptron (MLP)). For image diffusion, the latent diffusion paradigm may be adopted to encode full-size (224, 224, 3) images into (28, 28, 4) latent images (e.g., using a frozen SDXL VAE). Then, the latent images may be patchified (e.g., using a spatiotemporal patchifier, such as of size (4, 4, 2)). These image patch embeddings may then be concatenated with the action embeddings and passed into the transformer backbone. The image noising and denoising processes are performed in the latent space, and the final image sample is decoded (e.g., using the same VAE) to generate full-size images.

### Experiments

Empirically, it was found through certain experiments that adding redundant tokens that are eventually discarded (e.g., registers) helps with model performance. This may be because images and actions are distinct modalities that can benefit from having an intermediary medium to exchange information. However, since all output embeddings of the diffusion transformer are meaningful noise predictions, there is no room for such communication. The registers can store information from either modality, which can then be retrieved in subsequent transformer layers. The effectiveness of registers in the ablation experiments are demonstrated as follows.

The effectiveness of UWM as a pretraining method for learning the dynamics information from large multitask robotic datasets was evaluated. To train a UWM on robot data, sequences of observations and actions from a dataset were sampled, (o, a, o′) tuples were constructed, random diffusion timesteps ta, to′~U (0, T) were sampled, and the denoising score matching objective was optimized.

Moreover, UWM enables co-training on action-free video data by using diffusion timesteps for masking. Given action-free video samples, instead of sampling the action timestep randomly, the action timestep was fixed to T, the missing actions with random noise were imputed, and the loss was optimized. The effectiveness of co-training on videos in the experiments were validated, as described below.

In certain experiments, the following questions were examined: (1) can UWM effectively learn from large robotic datasets as a pretraining paradigm? (2) can UWM further benefit from additional video data without action labels in a co-training paradigm? (3) what are the key design choices that contribute to UWM's performance? These questions are answered through a number of robot experiments with a Franka robot using the DROID manipulation platform, as well as simulated experiments in the LIBERO benchmark.

Regarding baselines, UWM was compared to the following baselines throughout the experiments. Detailed descriptions of each baseline are provided, below.

Diffusion Policy (DP) is a behavior cloning method that fits a conditional diffusion model to a dataset of expert observation-action data. The framework to the pretraining-finetuning setting was extended by fitting a model to the behavior distribution of a multitask dataset and then finetuning it to the task-specific demonstrations. A comparison was made to DP as a baseline to validate the effectiveness of the additional supervisory signals in UWM. To minimize the discrepancy from UWM, a diffusion transformer backbone was adopted instead of a UNet architecture.

PAD is a video-action diffusion model that learns a joint distribution of actions and future observations conditioned on current observations. The key conceptual difference between PAD and UWM is the decoupling of timesteps between actions and next-observations in UWM. In addition, PAD conditions the model on the current observations by concatenating the clean latents of the current observations to the noisy latents of the next observations along the channel dimension. PAD supports co-training on videos by masking the action tokens with a learned mask token.

GR1 is a video-action transformer model that predicts actions and future image observations conditioned on current image observations. Unlike other baselines, GR1 does not model a distribution over data using a diffusion process. Instead, it directly regresses the actions and images by minimizing a least squares loss. A comparison was made to GR1 to validate the effectiveness of diffusion as a pretraining objective relative to regression. GR1 supports co-training on videos by masking the action tokens with a learned mask token.

For experiments with a robot, to evaluate UWM and baselines as pretraining methods, the DROID dataset was leveraged as a source of pretraining data. The DROID dataset is a diverse dataset consisting of robot trajectories collected across various institutions and operators, covering a large variety of tasks, camera positions, and backgrounds in natural settings. A pretraining dataset was curated by sampling a subset of 2,000 trajectories from the DROID dataset based on location. For methods that support co-training on video data (e.g. GR1, PAD, and UWM), their capability of learning from action-free videos was additionally evaluated. To this end, another 2,000 trajectories were sampled from the rest of the DROID dataset, and their action annotations were removed to use them as videos.

To evaluate the efficacy of the pretrained models, five different real-world tasks were constructed using the portable manipulation platform proposed in DROID. The tasks involved different kinds of robotic manipulation: (1) “Stack-Bowls” involved picking up a pink bowl and stacking it on top of a blue bowl; (2) “Block-Cabinet” involved opening a cabinet, grasping a small red block from a table, and placing it in the cabinet; (3) “Paper-Towel” involved precisely grasping a paper towel roll from the cabinet and placing it upright on a wooden stand on the table; (4) “Hang-Towel” (deformable object) involved grasping a towel by the corner and hanging it on a hook attached to the cabinet; (5) “Rice-Cooker” (long horizon) involved pouring a cup of rice into the inner pot of a rice cooker, and putting the inner pot in the rice cooker.

Each of these tasks involved positional and visual generalization, and required reasonably precise robotic manipulation. The finetuning datasets were curated by teleoperating the robot and collecting a dataset of expert trajectories.

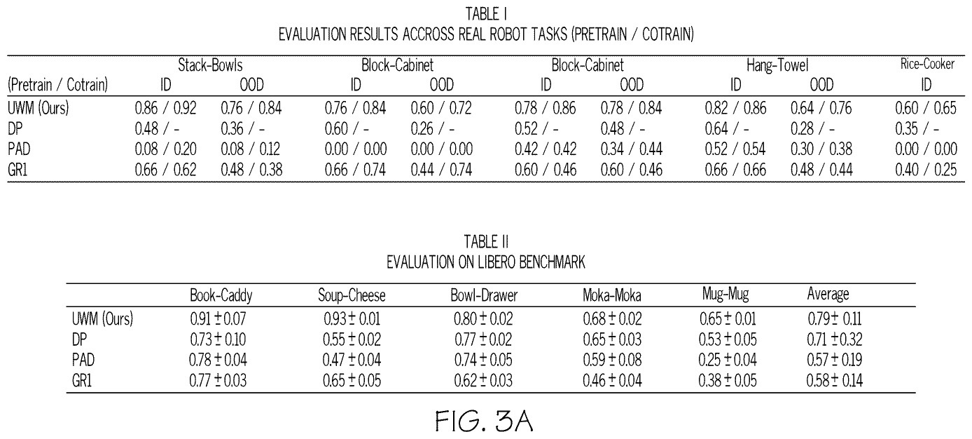

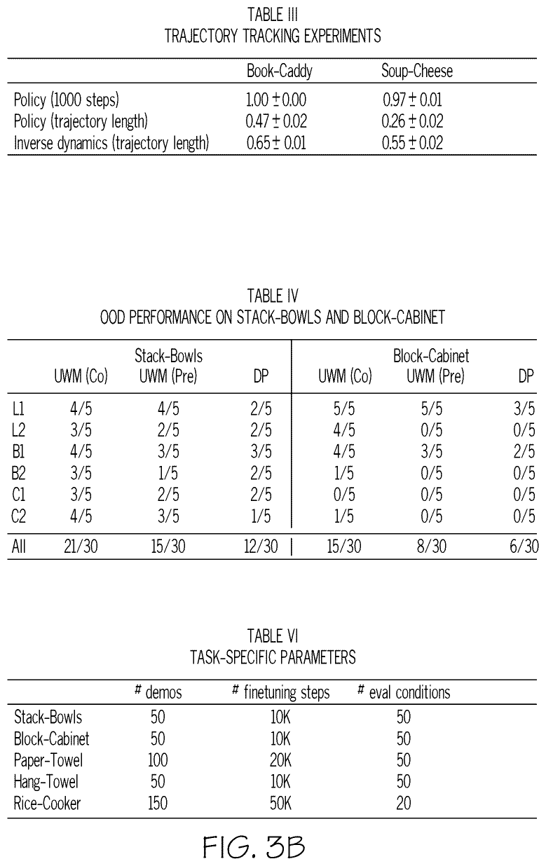

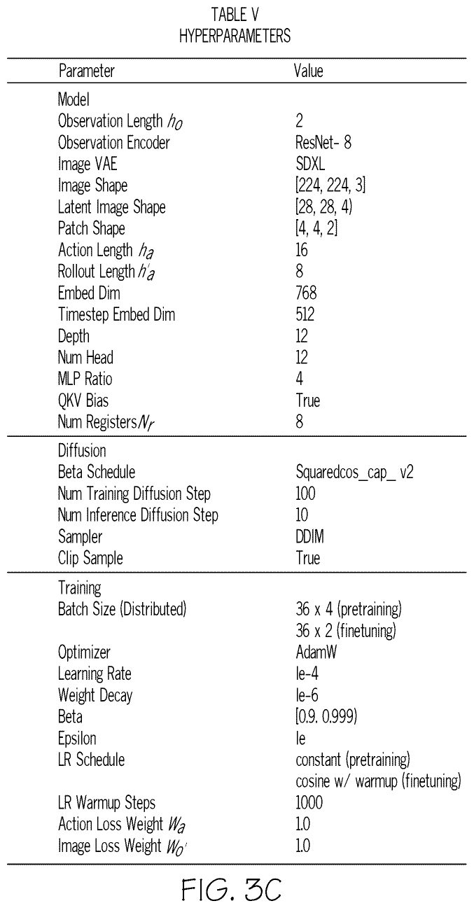

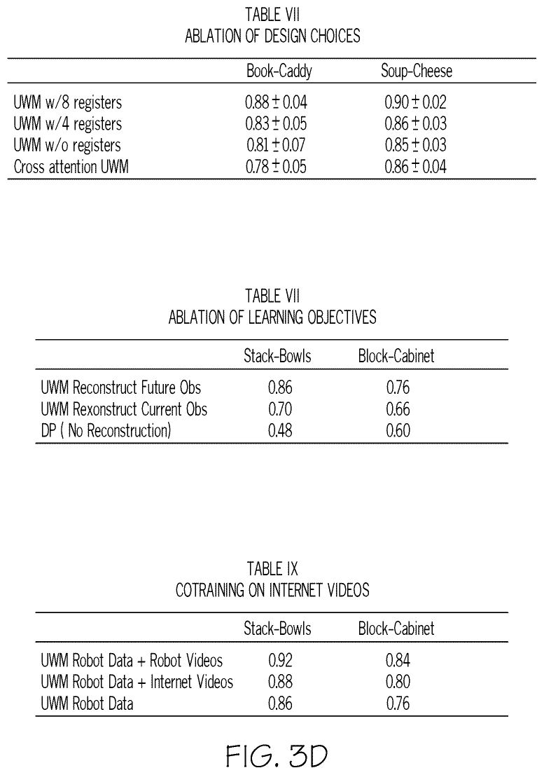

All methods were trained on the pretraining/co-training datasets for 100K steps and then finetuned to the evaluation tasks (task-specific parameters shown in TABLE VI shown in FIG. 3B). For co-training experiments, the robot and video datasets were mixed up, and batches were sampled uniformly from the mixture dataset, where each batch may contain action-labeled and action-free data. The method-specific masking techniques were then applied to optimize the co-training loss. For each task, evaluation was performed in scenarios approximately similar to those encountered during data collection (referred to as in-distribution), and an out-of-distribution evaluation setting was also constructed by introducing distractions that are unseen in the finetuning dataset. To ensure statistically significant evaluation, each task was tested on a fixed set of randomly chosen initialization positions. Details for the task-specific setups are described, below.

The results on the robot experiments are shown in TABLE I (shown in FIG. 3A). For each method and task, results are provided in the in-distribution (ID) and out-of-distribution (OOD) scenarios. Furthermore, for methods that support co-training on videos, the results of co-trained models are additionally reported (separated by “/”).

The pretraining results were examined in the in-distribution setting. This set of experiments reflect the models' ability to accurately capture the expert policy's distribution. UWM achieved the highest success rates across all five tasks among the methods, surpassing the best baseline by as much as 20%. This demonstrates the strength of coupled action-video diffusion in absorbing rich dynamic information from multitask datasets. In particular, since the model is trained to capture all possible conditional and marginal distributions, it is instilled with an understanding of the causal relationship between actions and image observations, resulting its superior performance compared to joint prediction models such as GR1 and PAD. GR1 output the second best results, establishing a baseline performance for deterministic regressive models. Diffusion Policies did not appear to successfully leverage the rich and dynamic pixel information in the pretraining datasets, appearing to be not as efficient at learning from diverse multitask trajectories. PAD achieved lower success for various experiments. Its low performance may be attributed to the conditioning via concatenation. Compared to UWM which takes in image features preprocessed by an encoder, PAD takes in raw pixels, thus needing to incorporate the feature extraction in the same transformer model. This may be a limitation in performance at accurately capturing the conditional action distribution without expanding model capacity.

The OOD scenarios were examined. This set of experiments tests the models' robustness to distribution shifts. The models experienced performance drops in the presence of visual distractions. This was especially pronounced in Stack-Bowls, Block-Cabinet, and Hang-Towel. In the Paper-Towel task, the models seemed unaffected by the visual distractions, potentially due to the task not requiring the models to pay attention to the table top when grasping the paper towel. Despite a slight performance drop compared to the ID setting, UWM outperformed the baselines, showing strong robustness under distribution shifts.

The methods' potential to scale with videos was tested by co-training with action-free videos. Results are reported after the “/” in each entry of Table I shown in FIG. 3A. UWM consistently showed improved performance when exposed to additional videos during pretraining. This may show using diffusion time steps for masking as an effective strategy for co-training on multimodal data. While GR1 was able to learn from videos by masking the actions with a learnable token, mixed results were shown of the co-trained model. In Stack-Bowls, Paper-Towel, and Rice-Cooker, the co-trained GR1 model was worse than the pretrained model, which may imply that incorporating videos dilutes the action learning signal. While PAD showed weaker positive transfer as a result of co-training, its baseline performance was suboptimal. As shown in TABLE IV shown in FIG. 3B, evaluations were performed in a larger set of OOD scenarios, and video co-training was found to provide significant gains in those settings.

Certain simulated experiments were performed to validate these findings in standard community benchmark settings, where the methods were evaluated on the LIBERO simulation benchmark. The LIBERO-100 benchmark consists of 90 training environments across multiple scenes and 10 evaluation environments, each with accompanying expert demonstrations. The demonstrations were combined from the 90 training environments to construct a multitask training dataset, and finetune on a random subset of the evaluation environments. To evaluate the methods' generalization capabilities, distribution shifts were introduced to evaluation environments by enlarging the range of initialization for all objects and removing objects from the scene. The details for this setup are described, below.

Each method was pretrained on the multitask dataset for 100K gradient steps, and finetuned on the downstream tasks for 10K gradient steps. 3 random seeds were finetuned for each method on each environment, and evaluated on 50 different initializations. TABLE II shown in FIG. 3A shows the average success rates across initializations with confidence intervals across random seeds. UWM achieved the highest success rates across the evaluation tasks in the out-of-distribution setting. DP achieved the second highest performance, followed by GR1 and PAD. These results imply that UWM effectively learns from large robotic datasets, due to its use of pixel reconstruction as an auxiliary signal and the independent diffusion timesteps instilling the model with a causal understanding of actions and observations.

Although the method described herein showed an improvement over baselines, the improvement in OOD scenarios was less than that in the real robot experiments, which may have been an artifact of the simulations having simpler dynamics than what is in the real world.

In addition, analysis and ablation experiments were conducted to help understand the various components and design choices in UWM. Additional experiments are described, below.

For forward dynamics, to examine the world modeling component of UWM, the forward dynamics prediction of UWM was visualized on simulated and real-world domains. To generate samples from the forward dynamics model, image diffusion was performed while the action diffusion timestep was fixed to 0 and the action tokens were fixed to be the ground truth actions. UWM accurately predicted the image observations conditioned on actions, closely resembling the ground truth image observations. This may imply that UWM can effectively model the conditional distribution.

For inverse dynamics, the inverse dynamics mode of UWM was evaluated on trajectory tracking, where a reference expert trajectory was provided and the inverse dynamics model was queried to track it. Specifically, for each reference trajectory, the simulation environment was reset to match the exact initial state of this trajectory. At each step, the ground truth future observations were taken from the trajectory and the inverse dynamics mode of a finetuned UWM was used to generate corresponding actions. Table III shown in FIG. 3B shows the results of tracking 50 trajectories from the LIBERO training datasets. Given the same time limit as the trajectory length, the inverse dynamics model achieved a higher success rate than the policy. This may imply that actions generated by the inverse dynamics adhere more closely to the reference trajectory. While the policies deviate from the reference trajectories, they eventually recover and solve the tasks given enough time.

For categorized OOD experiments, UWM and DP were evaluated in several more out-of-distribution (OOD) settings to study their generalization patterns. Certain scenes were constructed with varied lighting conditions (including static and disco lights), backgrounds, and clutter. For each scene, 5 initializations were randomly selected for evaluation. Results in TABLE IV shown in FIG. 3B show that across the board, UWM co-trained on videos (indicated by Co) is significantly more robust than both UWM (Pre) and DP pretrained on robot data.

For real-world learning from scratch, to study UWM's ability to scale with pretraining, UWM and DP were trained on the task-specific expert demonstrations from scratch for the same number of steps as the finetuning stage of the experiments in TABLE I shown in FIG. 3A. It was found that UWM and DP perform similarly when trained from scratch. However, UWM scales from pretraining more effectively than DP.

Additional details (e.g., additional implementation or other details) are provided, below, with respect to the description of the experiments described above.

Regarding model architecture, the implementation of UWM was based on the diffusion transformer architecture with AdaLN conditioning. The inputs to the model were (o, aₜₐ, o′_{to′}, tₐ, t_{o′}), where o is a sequence of observations from n_{c} camera views, aₜₐ is a sequence of noisy actions, o′_{to′} is a sequence of noisy observations from each camera view after the actions, and tₐ, t_{o′} are diffusion timesteps. The observations were encoded into features using a ResNet-18 encoder, which was initialized using the ImageNet pretrained weights and updated throughout training. The timesteps tₐ and t_{o′} were encoded into features via a sinusoidal embedding network. The image features were flattened and concatenated with the timestep embeddings and used to condition each transformer block via AdaLN layers.

The input sequence to the transformer consisted of encoded tokens from aₜₐ, o′_{to′} and additional register tokens. The actions were encoded to tokens using a shallow MLP encoder shared across timesteps. For images, the latent diffusion paradigm was followed, and the raw image observations were downsampled into latent space using a frozen VAE from Stable Diffusion XL. The image latents were patchified into patch embeddings using a 3D convolution layer. The action embeddings, the image patch embeddings, and the learnable register tokens were concatenated along the sequence dimension and passed as input to the transformer model. A learnable positional embedding was added to the inputs to encode positional information. To decode action and image noise predictions from the model outputs, the respective tokens (discarding registers) were taken and decoded using shallow MLP networks. The image noise predictions were in the latent space, and only the final image prediction was decoded at the end of the sampling procedure.

Regarding training and inference details, given a transition tuple (o, a, o′) from information sampled from the dataset, random cropping and augmentations were first applied to the image observations. The cropping and augmentation parameters were kept temporally consistent across o and o′ but differed from camera view to camera view. Then, action and observation diffusion timesteps tₐ, t′ₒ were sampled independently from the uniform distribution U (0, T). These were used to sample noisy actions aₜₐ and observations o′_{t′o} according to the forward diffusion process. The tuple (o, aₜₐ, o′_{to′}, tₐ, t_{o′}) was passed as input to the model, which output the action and observation noise predictions. The model was trained by optimizing the diffusion loss.

To co-train the model on video data, a robot dataset and a video dataset were combined to get a mixture dataset and sample batches of transition tuples from the mixture dataset uniformly at random. Each batch contained a mixture of video data and action data. For the action-free video samples in each batch, the corresponding action diffusion timesteps were set to tₐ=T, to impute the missing actions with random actions drawn from the unit Gaussian distribution. The action diffusion loss was computed across all samples in a batch (both robot samples and video samples).

The model was then optimized using the AdamW optimizer. For pretraining experiments, a constant learning rate was used. For finetuning experiments, a cosine annealed learning rate with warmup was used. Sampling was done from the reverse diffusion processes using the DDIM sampler to speed up inference. At deployment, the first h′ₐ action predictions were performed followed by replanning. All model and training hyperparameters are provided in TABLE V shown in FIG. 3C.

While UWM is generally stable with respect to hyperparameters, for pretraining on highly multimodal datasets, increasing the number of registers was helpful in improving performance. For new datasets, the default hyperparameters may be tried first, and then the number of registers may be tuned for potential performance gains.

Regarding training compute, training a UWM on the DROID dataset for 100K gradient steps with the hyperparameters shown in TABLE V shown in FIG. 3C took 24 hours on 4 NVIDIA A100 GPUs using Pytorch DDP.

Regarding baseline details, for diffusion policies, the implementation of diffusion policies was based on the UWM model. The image tokens, image diffusion timestep, and registers were removed while everything else was kept identical.

For PAD, the implementation of PAD was based on the UWM model, replacing coupled action-image diffusion with joint diffusion, and the model being conditioned by concatenating the clean current observations to the noisy future observation predictions along the channel dimension. The diffusion timestep was still passed into the transformer via AdaLN. While the original PAD method predicts consecutive actions and future frames, it was adapted to predict sequences of actions and the following observations (same as UWM) to isolate the effect of key design differences such as joint video-action diffusion and conditioning method.

For GR1, a custom implementation of the GR1 model was used, which was adapted to have the same input-output format as UWM. Instead of regressing consecutive actions and observations, a sequence of actions and the following image observations were predicted. GR1 conditioned on the current observations by passing the ViT encoded observation tokens through a Perceiver resampler from Flamingo, and then concatenating the resulting tokens to the input sequence of the transformer model. The rest of input sequence for the transformer consisted of learnable action and observation tokens. The output tokens were passed into respective decoders (MLP for actions, DiT decoder for image patches) to regress the modalities.

Regarding additional details on real-world experiments, for robot setup, real-world experiments were conducted using a Franka Panda robot in the DROID setup. The robot's observation space consisted of two scene cameras and a wrist camera. An overhead camera was also mounted to track the initializations during evaluation. The robot operated at a control frequency of 10 Hz, allowing responsive and smooth task execution. The action space was defined by a delta end-effector (EE) pose, which specifies incremental positional and rotational adjustments relative to the current pose. Additionally, the gripper state was represented using a single continuous dimension, where 0 indicated the gripper is open and 1 indicated the gripper is closed.

For tasks, the task-specific settings are shown in TABLE VI shown in FIG. 3B.

For Stack-Bowls, the robot needed to pick up a red bowl on a counter and place it in a blue bowl. The positions of the bowls were randomized across the counter top. A rollout was successful if the red bowl was placed securely inside the blue bowl. For the OOD setup, the top cabinet and the bottom drawer were opened, and unseen objects were placed on the counter and stovetop.

For Block-Cabinet, the robot needed to (1) open a left cabinet door by grasping the handle, and (2) pick up a red block from the counter top and place it on the bottom level of the cabinet. The position of the red block was randomized across the counter. A rollout was successful if the block was placed securely in the cabinet. For the OOD setup, the bottom drawer was opened, and unseen objects were placed on the counter and stovetop.

For Paper-Towel, the robot was tasked to take out a paper towel placed in an open cabinet and place it vertically on a base plate on the counter. The position of the paper towel was randomized across the cabinet shelf, and position of the base plate was randomized across the counter top. Success was counted if the paper towel was placed securely on the base plate and did not topple. For the OOD setup, the bottom drawer was opened, and unseen objects were placed on the counter and stovetop.

For Hang-Towel, the robot was tasked to pick up a towel from the counter and hang it on a hook on the cabinet. The position and shape of the towel were randomized during data collection. For evaluation, the towel was folded carefully to ensure standardization. A rollout was successful if the towel hung on the hook and did not slip off. For the OOD setup, the bottom drawer was opened, and unseen objects were placed on the counter and stovetop.

For Rice-Cooker, this was a multistage task that involved (1) picking up a cup of rice, (2) pouring the rice into a bowl, (3) placing the cup back on the counter, (4) picking up the bowl and placing it in the rice cooker. The positions of all objects were randomized. A rollout was successful if there was minimal spill of rice and the bowl was placed securely in the rice cooker. This task was evaluated on 20 initializations that are close to the dataset distribution. This task was not evaluated in OOD settings.

Regarding evaluation protocol, to ensure fairness of real-robot evaluations, an overhead camera and a Python program were used to systematically track randomizations. The program overlaid the reference frame onto the current frame, so the user could adjust the objects to match the reference frame. All tasks except Rice-Cooker were evaluated on 50 randomly generated configurations. Rice-Cooker was evaluated on 20 configurations close to the data distribution. To mitigate the effects of camera shake due to the mounting mechanism, each method was given three attempts per initialization, making for a more robust evaluation across trials.

Regarding failure modes, a description of some common failure modes was provided in the real-world experiments. Although three cameras were utilized to maximize coverage, certain angles resulted in objects being visible to only one camera. These limited viewpoints made some initializations more challenging for the robot to complete the tasks successfully. Additionally, variability in object behavior contributed to task failures. For instance, in the Paper-Towel task, the robot often placed the paper towel on the wooden platform, but the angle of placement may have caused the paper towel to topple over. In the Stack-Bowls task, a source of failure for baseline methods was their inability in distinguishing between the blue bowl and the distractor when attempting to locate the blue bowl after picking up the pink bowl. This issue does not occur with the proposed method described herein.

Regarding simulated environments, LIBERO is a simulated robotic benchmark designed to evaluate lifelong learning algorithms. It involves controlling a 7-DoF Franka Panda robot to complete various tasks across different scenes. The LIBERO-100 benchmark consists of 100 tasks distributed across three scenes (kitchen, living room, study), each with 50 accompanying expert demonstrations. The 100 tasks are split into 90 tasks for training (LIBERO-90) and 10 tasks for evaluation (LIBERO-10).

For the experiments, the combined LIBERO-90 dataset was used as the pretraining data, totaling 4,500 trajectories. Evaluation was performed on a random subset of 5 tasks from LIBERO-10. For each task, the pretrained models were finetuned on 50 expert demonstrations. To evaluate the generalization capabilities of the methods, the simulation configuration was modified to introduce distribution shifts during the evaluation. Specifically, the initialization range of each object was increased by 0.03 to generate unseen initializations and background objects were removed to introduce visual distribution shifts. A description of the evaluation tasks is provided, below.

For Book-Caddy, the robot needed to pick up a book from a table top and place it in the back of a caddy.

For Soup-Cheese, the robot needed to place an alphabet soup and cheese in a basket in sequence.

For Bowl-Drawer, the robot needed to pick up a bowl, place it in a bottom drawer, and close the drawer.

For Moka-Moka, the robot needed to pick up the two Moka cups from a table and place them on an electric stove.

For Mug-Mug, the robot needed to place a left mug in a left plate and place a right mug in a right plate.

Regarding additional experiments, for ablations of design choices, to understand the effect of UWM's design choices, ablation studies were conducted on two simulated tasks from the LIBERO environment. Specifically, an attempt was made to (1) understand the effect of registers on task performance, and (2) compare the use of AdaLN for observation conditioning with cross attention. Each model was trained on the single-task datasets from scratch (without pretraining), and evaluation was performed on 50 initializations across 3 seeds.

Results in TABLE VII shown in FIG. 3D show that adding registers to the transformer help improve the model performance. Adding registers may facilitate the exchange of information between actions and latent image patches, which are distinct modalities. Replacing AdaLN conditioning with cross attention resulted in worse performance. One possible explanation is that action prediction tasks benefit more from AdaLN's global modulation than from the per-token local modulation provided by cross-attention. This finding may not apply to other modalities such as language.

For ablation of learning objectives, to evaluate whether the performance gain of UWM is a result of dynamics prediction or pure reconstruction, a UWM was pretrained to reconstruct the current observations instead of the future observations. This incentivizes the model to learn about image features, but not about temporal dynamics. TABLE VIII shown in FIG. 3D shows that while reconstructing the current observations improves upon the base DP architecture with no image reconstruction, it was found advantageous to reconstruct future observations. This indicates that the model benefits from predicting dynamics rather than purely just image features.

For learning from Internet videos, evaluation was performed regarding whether UWM can leverage knowledge from Internet videos by including a mixture of Kinetics-400 and Something-Something-v2 dataset in the training, which contain video clips of human activities. Since the DROID setup has 3 camera views, random crops of the same video were used to impute the missing camera views. Results in TABLE IX shown in FIG. 3D indicate that co-training on Internet videos shows some improvement on training only on robot data, but co-training with in-domain robot videos still performs better. These gains may be amplified in more challenging tasks and testing conditions.

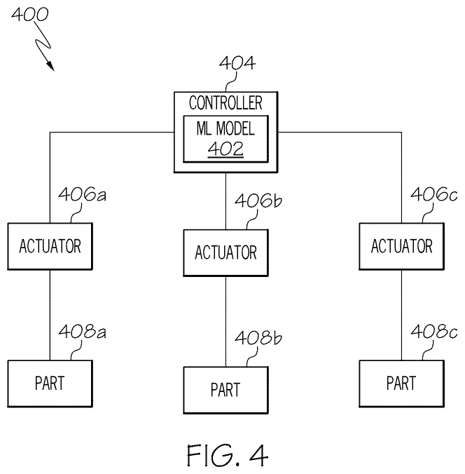

FIG. 4 is a block diagram illustrating components of an example ML model system 400. As depicted, the system 400 includes a controller 404 including ML model 402, where ML model 402 is an example of the unified diffusion transformer model 102 of FIG. 1, described further with reference to FIG. 2. In certain examples, the controller 404 may be a controller for a robot system or a vehicle control system. Other examples of systems may also be possible consistent with the present disclosure.

The system 400 includes a plurality of actuators 406 (actuators 406a-c) coupled to the controller 404 and to a plurality of parts 408 (parts 408a-c), where the parts 408 may be parts for a robot system, a vehicle control system, or similar. Based on the prediction by ML model 402 (e.g., trained based on the methods described herein), the controller 404 may determine how the parts 408 may be actuated, respectively, by the actuators 406, such as to control a robot or a vehicle. For example, the controller 404 may generate and send (to an actuator) a control signal based on the prediction by ML model 402, such as to cause the part to be actuated according to the prediction.

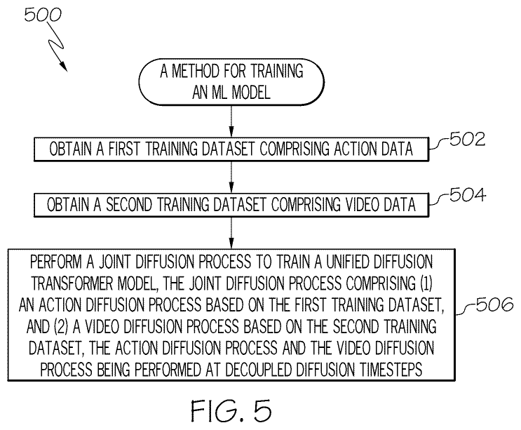

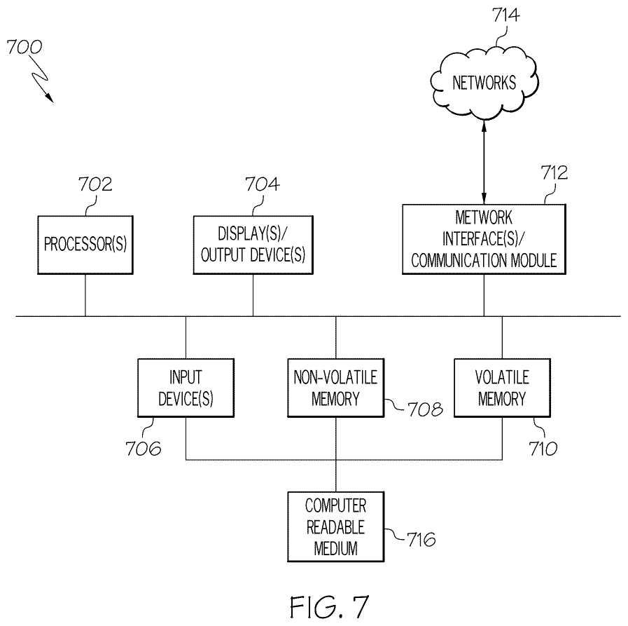

FIG. 5 is a flow chart depicting an example process, method 500. Method 500 may be performed for training an ML model. In certain embodiments, method 500 can be implemented by the system 100 of FIG. 1, the system 400 of FIG. 4, and/or computing device 700 of FIG. 7.

Method 500 begins, at block 502, with obtaining a first training dataset comprising action data. In certain embodiments, the action data may be an example of the actions used for training (e.g., pretraining) the unified diffusion transformer model 102 of FIG. 1, such as described with reference to FIG. 1 or 2. In certain embodiments, at block 502, method 500 may begin with obtaining a first training dataset comprising data of a first modality. In some cases, the data of the first modality may include the action data.

Method 500 proceeds, at block 504, with obtaining a second training dataset comprising video data. In certain embodiments, the video data may be an example of the action-free videos, action-free video samples, or action-free video data used for training (e.g., pretraining) the unified diffusion transformer model 102 of FIG. 1, such as described with reference to FIG. 1 or 2. In certain embodiments, at block 504, method 500 may proceed with obtaining a second training dataset comprising data of a second modality. In some cases, the data of the second modality may include the video data.

Method 500 proceeds, at block 506, with performing a joint diffusion process to train a unified diffusion transformer model, the joint diffusion process comprising (1) an action diffusion process based on the first training dataset, and (2) a video diffusion process based on the second training dataset, the action diffusion process and the video diffusion process being performed at decoupled diffusion timesteps. In certain embodiments, the unified diffusion transformer model may be an example of the unified diffusion transformer model 102 of FIG. 1, such as described with reference to FIG. 1 or 2. In certain embodiments, at block 506, method 500 may proceed with performing a joint diffusion process to train a unified diffusion transformer model, the joint diffusion process comprising (1) a first diffusion process based on the first training dataset, and (2) a second diffusion process based on the second training dataset, the first diffusion process and the second diffusion process being performed at decoupled diffusion timesteps. In some cases, the first diffusion process may include the action diffusion process, and the second diffusion process may include the video diffusion process.

In certain embodiments, the action data comprises a data instance indicative of an action by a robot.

In some embodiments, the video data comprises a data instance indicative of an image sequence of an environment, and excludes any data instance indicative of how a robot is controlled to perform an action.

In certain embodiments, performing the joint diffusion process comprises fixing the action diffusion process at a timestep.

In certain embodiments, performing the joint diffusion process comprises fixing the video diffusion process at a timestep.

In certain embodiments, performing the joint diffusion process to train the unified diffusion transformer model comprises training the unified diffusion transformer model as a coupled score model that predicts action scores and future image scores based on (1) a current image, and (2) separate diffusion timesteps for an action and a future image.

In certain embodiments, performing the joint diffusion process comprises sampling timesteps for the action diffusion process and the video diffusion process at random, wherein the sampled timesteps comprise a plurality of permutations of different action noises and image noises.

In some embodiments, the method 500 provides for training a unified world model, which is a diffusion based framework that unifies policy learning and world modeling into a single flexible framework. Such a model may be instantiated with a coupled conditional diffusion process using separate timesteps for actions and future observations. During training, the model is exposed to all combinations of timesteps covering various conditional and marginal distributions, instilling the model with an understanding of the causal relationship between actions and future observations. This distinguishes the UWM described herein from traditional imitation learning approaches, which often lack a nuanced understanding of causal dependencies. Moreover, the independent diffusion timesteps allow for a natural connection between noising and partial masking, enabling the use of action-free videos for co-training, as well as for marginalization and conditioning of the variables by appropriately setting timesteps. The resulting model is then able to flexibly perform inference as a policy, a video prediction model, a forward dynamics model, and an inverse dynamics model. As shown through a thorough experimental evaluation, such a UWM provides significant gains over imitation learning across the board by enhancing large scale pretraining from robotic datasets.

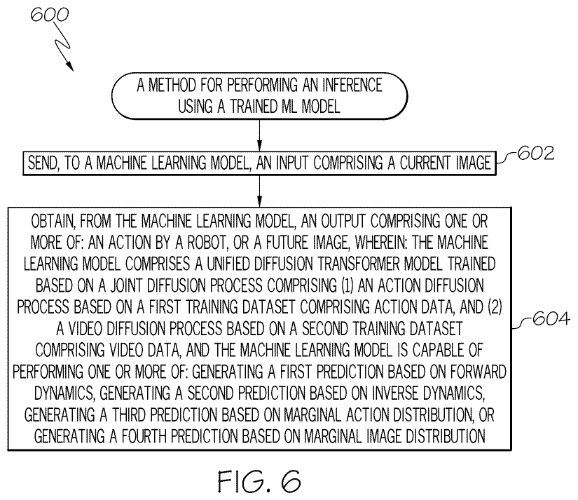

FIG. 6 is a flow chart depicting an example process, method 600. Method 600 may be performed for performing an inference using a trained ML model. In certain embodiments, method 600 can be implemented by the system 100 of FIG. 1, the system 400 of FIG. 4, and/or computing device 700 of FIG. 7, where the trained ML model may be trained based on the methods described herein.

Method 600 begins, at block 602, with sending, to a machine learning model, an input comprising a current image. In certain embodiments, the machine learning model may be an example of the unified diffusion transformer model 102 of FIG. 1, described herein with reference to FIG. 1 or 2.

Method 600 proceeds, at block 604, with obtaining, from the machine learning model, an output comprising one or more of: an action by a robot, or a future image, wherein: the machine learning model comprises a unified diffusion transformer model trained based on a joint diffusion process comprising (1) an action diffusion process based on a first training dataset comprising action data, and (2) a video diffusion process based on a second training dataset comprising video data, and the machine learning model is capable of performing one or more of: generating a first prediction based on forward dynamics, generating a second prediction based on inverse dynamics, generating a third prediction based on marginal action distribution, or generating a fourth prediction based on marginal image distribution. In certain embodiments, the machine learning model may be an example of the unified diffusion transformer model 102 of FIG. 1, described herein with reference to FIG. 1 or 2.

In certain embodiments, the machine learning model is capable of performing generating the first prediction based on the forward dynamics, the input comprises the current image and another action by the robot, and the output comprises the future image.

In some embodiments, the machine learning model is capable of performing generating the second prediction based on the inverse dynamics, the input further comprises another future image, and the output comprises the action by the robot.

In certain embodiments, the machine learning model is capable of performing generating the third prediction based on the marginal action distribution, the input comprises only the current image, and the output comprises the action by the robot.

In some embodiments, the machine learning model is capable of performing generating the fourth prediction based on the marginal image distribution, the input comprises only the current image, and the output comprises the future image.

In certain embodiments, method 600 further comprises performing the joint diffusion process to train the unified diffusion transformer model.

In some embodiments, performing the joint diffusion process comprises fixing the action diffusion process at a timestep.

In certain embodiments, performing the joint diffusion process comprises fixing the video diffusion process at a timestep.

In some embodiments, performing the joint diffusion process to train the unified diffusion transformer model comprises training the unified diffusion transformer model as a coupled score model that predicts action scores and future image scores based on (1) the current image, and (2) separate diffusion timesteps for the action and the future image.

In certain embodiments, performing the joint diffusion process comprises sampling timesteps for the action diffusion process and the video diffusion process at random, wherein the sampled timesteps correspond to a plurality of permutations of different action noises and image noises.

In some embodiments, the method 600 provides for generating a prediction with a unified world model, which is a diffusion based framework that unifies policy learning and world modeling into a single flexible framework. Such a model may be instantiated with a coupled conditional diffusion process using separate timesteps for actions and future observations. During training, the model is exposed to all combinations of timesteps covering various conditional and marginal distributions, instilling the model with an understanding of the causal relationship between actions and future observations. This distinguishes the UWM described herein from traditional imitation learning approaches, which often lack a nuanced understanding of causal dependencies. Moreover, the independent diffusion timesteps allow for a natural connection between noising and partial masking, enabling the use of action-free videos for co-training, as well as for marginalization and conditioning of the variables by appropriately setting timesteps. The resulting model is then able to flexibly perform inference as a policy, a video prediction model, a forward dynamics model, and an inverse dynamics model. As shown through a thorough experimental evaluation, such a UWM provides significant gains over imitation learning across the board by enhancing large scale pretraining from robotic datasets.

Turning to FIG. 7, a block diagram illustrates an example of a computing device 700, through which embodiments of the disclosure can be implemented, such as (by way of non-limiting example) system 100 of FIG. 1, system 400 of FIG. 4, and/or any other device described herein. The computing device 700 described herein is but one example of a suitable computing device and does not suggest any limitation on the scope of any embodiments presented. Nothing illustrated or described with respect to the computing device 700 should be interpreted as being required or as creating any type of dependency with respect to any element or plurality of elements. In various embodiments, a computing device 700 may include, but need not be limited to, system 100 of FIG. 1 or system 400 of FIG. 4. In an embodiment, the computing device 700 includes at least one processor 702 and memory, such as non-volatile memory 708 and/or volatile memory 710. The computing device 700 can include one or more displays and/or output devices 704 such as monitors, speakers, headphones, projectors, wearable-displays, holographic displays, and/or printers, for example. The computing device 700 may further include one or more input devices 706 which can include, by way of example, any type of mouse, keyboard, disk/media drive, memory stick/thumb-drive, memory card, pen, touch-input device, biometric scanner, voice/auditory input device, motion-detector, camera, scale, etc.

The computing device 700 may include non-volatile memory 708, volatile memory 710, or a combination thereof. Examples of non-volatile memory 708 may include read only memory (ROM), flash memory, etc. Examples of volatile memory 710 may include random access memory (RAM), etc. A network interface 712 can facilitate communications over a network 714 via wires, via a wide area network, via a local area network, via a personal area network, via a cellular network, via a satellite network, etc. Suitable local area networks may support wired Ethernet and/or wireless technologies such as, for example, wireless fidelity (Wi-Fi). Suitable personal area networks may support wireless technologies such as, for example, IrDA, Bluetooth, Wireless USB, Z-Wave, ZigBee, NFC and/or other short distance communication protocols. Suitable personal area networks may similarly support wired computer buses such as, for example, USB and FireWire. Suitable cellular networks may support, but are not limited to, technologies such as LTE, WiMAX, UMTS, CDMA, and GSM. Network interface 712 can be communicatively coupled to any device capable of transmitting and/or receiving data via the network 714. Accordingly, the hardware of the network interface 712 can include a communication transceiver for sending and/or receiving any wired or wireless communication. For example, the network interface hardware may include an antenna, a modem, LAN port, Wi-Fi card, WiMax card, mobile communication hardware, short distance communication hardware, satellite communication hardware and/or any wired or wireless hardware for communicating with other networks and/or devices.

A computer readable storage medium 716 may include a plurality of computer readable mediums, each of which may be either a computer readable storage medium or a computer readable signal medium. A computer readable storage medium 716 may reside, for example, within an input device 706, non-volatile memory 708, volatile memory 710, or any combination thereof. A computer readable storage medium 716 can include tangible media that is able to store instructions associated with, or used by, a device or system. A computer readable storage medium 716 includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A computer readable storage medium 716 may also include, for example, a system or device that is of a magnetic, optical, semiconductor, or electronic type. Computer readable storage mediums and computer readable signal mediums are mutually exclusive. For example, system 100 of FIG. 1 or system 400 of FIG. 4 may utilize a computer readable storage medium to store data related to training, or performing an inference using, the unified diffusion transformer model 102 of FIG. 1 or ML model 402 of FIG. 4.

A computer readable signal medium can include any type of computer readable medium that is not a computer readable storage medium and may include, for example, propagated signals taking any number of forms such as optical, electromagnetic, or a combination thereof. A computer readable signal medium may include propagated data signals containing computer readable code, for example, within a carrier wave. Computer readable storage media and computer readable signal media are mutually exclusive.

The computing device 700, such as corresponding to system 100 of FIG. 1 or system 400 of FIG. 4 may include one or more network interfaces 712 to facilitate communication with one or more remote devices, which may include, for example, client and/or server devices. In various embodiments, the computing device 700 may be configured to communicate over a network, such as network 714, with a server or other network computing device to transmit and receive data related to training, or performing an inference using, the unified diffusion transformer model 102 of FIG. 1 or ML model 402 of FIG. 4. A network interface 712 may also be described as a communications module, as these terms may be used interchangeably.

As illustrated above, various embodiments for training, or generating a prediction with, a unified diffusion transformer model are disclosed. It would be apparent to one of ordinary skill in the art that, while certain embodiments are described with respect to training an ML model for a robot system or a vehicle control system, embodiments of the present disclosure can be used for other applications without departing from the spirit and the scope of the present disclosure. Embodiments of the present disclosure provide technical benefits and advance the state of the art in robot or other device control.

It is noted that recitations herein of a component of the present disclosure being “configured” or “programmed” in a particular way, to embody a particular property, or to function in a particular manner, are structural recitations, as opposed to recitations of intended use. More specifically, the references herein to the manner in which a component is “configured” or “programmed” denotes an existing physical condition of the component and, as such, is to be taken as a definite recitation of the structural characteristics of the component.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

It should now be understood that embodiments disclosed herein includes systems, methods, and non-transitory computer-readable mediums for a unified diffusion transformer model. It should also be understood that these embodiments are merely exemplary and are not intended to limit the scope of this disclosure.

What is claimed is:

1. An apparatus, comprising:
one or more processors coupled to one or more memories and configured to:
obtain a first training dataset comprising data of a first modality;
obtain a second training dataset comprising data of a second modality; and
perform a joint diffusion process to train a unified diffusion transformer model, the joint diffusion process comprising (1) a first diffusion process based on the first training dataset, and (2) a second diffusion process based on the second training dataset, the first diffusion process and the second diffusion process being performed at decoupled diffusion timesteps.

2. The apparatus of claim 1, wherein:
the data of the first modality comprises action data,
the data of the second modality comprises video data,
the first diffusion process comprises an action diffusion process, and
the second diffusion process comprises a video diffusion process.

3. The apparatus of claim 2, wherein:
the action data comprises a data instance indicative of an action by a robot, and
the video data comprises a data instance indicative of an image sequence of an environment, and excludes any data instance indicative of how a robot is controlled to perform an action.

4. The apparatus of claim 2, wherein to perform the joint diffusion process, the one or more processors are configured to fix the action diffusion process at a timestep.

5. The apparatus of claim 2, wherein to perform the joint diffusion process, the one or more processors are configured to fix the video diffusion process at a timestep.

6. The apparatus of claim 2, wherein to perform the joint diffusion process to train the unified diffusion transformer model, the one or more processors are configured to train the unified diffusion transformer model as a coupled score model that predicts action scores and future image scores based on (1) a current image, and (2) separate diffusion timesteps for an action and a future image.

7. The apparatus of claim 2, wherein to perform the joint diffusion process, the one or more processors are configured to sample timesteps for the action diffusion process and the video diffusion process at random, wherein the sampled timesteps comprise a plurality of permutations of different action noises and image noises.

8. An apparatus, comprising:
one or more processors coupled to one or more memories and configured to:
send, to a machine learning model, an input comprising a current image; and
obtain, from the machine learning model, an output comprising one or more of:
an action by a robot, or
a future image,
wherein:
the machine learning model comprises a unified diffusion transformer model trained based on a joint diffusion process comprising (1) an action diffusion process based on a first training dataset comprising action data, and (2) a video diffusion process based on a second training dataset comprising video data, and
the machine learning model is capable of performing one or more of:
generating a first prediction based on forward dynamics,
generating a second prediction based on inverse dynamics,
generating a third prediction based on marginal action distribution, or
generating a fourth prediction based on marginal image distribution.

9. The apparatus of claim 8, wherein:
the machine learning model is capable of performing generating the first prediction based on the forward dynamics,
the input comprises the current image and another action by the robot, and
the output comprises the future image.

10. The apparatus of claim 8, wherein:
the machine learning model is capable of performing generating the second prediction based on the inverse dynamics,
the input further comprises another future image, and
the output comprises the action by the robot.

11. The apparatus of claim 8, wherein:
the machine learning model is capable of performing generating the third prediction based on the marginal action distribution,
the input comprises only the current image, and
the output comprises the action by the robot.

12. The apparatus of claim 8, wherein:
the machine learning model is capable of performing generating the fourth prediction based on the marginal image distribution,
the input comprises only the current image, and
the output comprises the future image.

13. The apparatus of claim 8, wherein the one or more processors are further configured to perform the joint diffusion process to train the unified diffusion transformer model.

14. The apparatus of claim 13, wherein to perform the joint diffusion process, the one or more processors are configured to fix the action diffusion process at a timestep.

15. The apparatus of claim 13, wherein to perform the joint diffusion process, the one or more processors are configured to fix the video diffusion process at a timestep.

16. The apparatus of claim 13, wherein to perform the joint diffusion process to train the unified diffusion transformer model, the one or more processors are configured to train the unified diffusion transformer model as a coupled score model that predicts action scores and future image scores based on (1) the current image, and (2) separate diffusion timesteps for the action and the future image.

17. The apparatus of claim 13, wherein to perform the joint diffusion process, the one or more processors are configured to sample timesteps for the action diffusion process and the video diffusion process at random, wherein the sampled timesteps correspond to a plurality of permutations of different action noises and image noises.

18. A method, comprising:
sending, to a machine learning model, an input comprising a current image; and
obtaining, from the machine learning model, an output comprising one or more of:
an action by a robot, or
a future image,
wherein:
the machine learning model comprises a unified diffusion transformer model trained based on a joint diffusion process comprising (1) an action diffusion process based on a first training dataset comprising action data, and (2) a video diffusion process based on a second training dataset comprising video data, and
the machine learning model is capable of performing one or more of:
generating a first prediction based on forward dynamics,
generating a second prediction based on inverse dynamics,
generating a third prediction based on marginal action distribution, or
generating a fourth prediction based on marginal image distribution.

19. The method of claim 18, further comprising performing the joint diffusion process to train the unified diffusion transformer model.

20. The method of claim 19, wherein performing the joint diffusion process comprises sampling timesteps for the action diffusion process and the video diffusion process at random, wherein the sampled timesteps correspond to a plurality of permutations of different action noises and image noises.
